(19) United States
(12) Patent Application Publication
(10) Pub. No.: US 2026/0046979 A1
(43) Pub. Date: Feb. 12, 2026

(54) ABNORMALITY DETERMINATION DEVICE, ABNORMALITY DETERMINATION METHOD, AND ABNORMALITY DETERMINATION PROGRAM

(71) Applicant: NHK SPRING CO., LTD., Yokohama-shi, Kanagawa (JP)

(72) Inventors: Yuto TSUDA, Yokohama-shi, Kanagawa (JP); Jun TOKUSHIGE, Yokohama-shi, Kanagawa (JP); Marino AKITA, Yokohama-shi, Kanagawa (JP); Ryota TAKATSUKI, Yokohama-shi, Kanagawa (JP)

(21) Appl. No.: 19/099,705

(22) PCT Filed: Aug. 7, 2023
(86) PCT No.: PCT/JP2023/028790

§ 371 Date: Jan. 29, 2025

(30) Foreign Application Priority Data
Aug. 12, 2022 (JP) 2022-128977

(51) Int. Cl. H05B 1/02; G05B 23/02; H05B 3/14

(52) U.S. Cl. CPC H05B 1/02; H05B 3/145; G05B 23/0235; H05B 2214/04

(57) ABSTRACT

An abnormality determination device includes: a calculation section that calculates a resistance value of a heater; a comparison section that compares the resistance value that was calculated by the calculation section in the past, and the resistance value calculated at a current time; and a detection section that detects an abnormality of the heater in a case in which a comparison value generated at the comparison section exceeds a threshold value.

### TECHNICAL FIELD

The present disclosure relates to an abnormality determination device, an abnormality determination method, and an abnormality determination program.

### BACKGROUND ART

Heaters used for human bodies have conventionally required a technique for preventing overheating at the time of use. There is a technique of cutting the connection between a pair of electrodes and a power source when the temperature of a heater becomes a predetermined temperature or higher, such as the technique of the disclosure put forth in Japanese Patent Application No. 2020-150624 for example.

### SUMMARY OF INVENTION

### Technical Problem

However, in a case in which a heater is damaged locally even if provided with a function for carrying out control by utilizing the upper limit of the temperature as in the technique of the disclosure put forth in Japanese Patent Application No. 2020-150624, because current continues to flow, there is the possibility that abnormalities may not be detected. Further, the technique of the disclosure put forth in Japanese Patent Application No. 2020-150624 cannot detect localized generation of heat.

The present disclosure was made in view of the above-described points, and an object thereof is to provide an abnormality determination device, an abnormality determination method and an abnormality determination program that can detect localized abnormalities of a heater.

### Solution to Problem

An abnormality determination device of a first aspect is structured to include: a calculation section that calculates a resistance value of a heater; a comparison section that compares the resistance value that was calculated by the calculation section in the past, and the resistance value calculated at a current time; and a detection section that detects an abnormality of the heater in a case in which a comparison value at the comparison section exceeds a threshold value.

Here, comparison values include the difference between a resistance value of the past and the resistance value at a current, and the rate of change in the resistance value at the current time from a resistance value of the past. In accordance with the abnormality determination device of the first aspect, an abnormality can be detected even in a case in which the heater is damaged locally.

An abnormality determination device of a second aspect is the abnormality determination device of the first aspect, wherein the calculation section calculates the resistance value periodically, and the comparison section compares the resistance value that was calculated by the calculation section at a previous time, and the resistance value calculated at the current time.

In accordance with the abnormality determination device of the second aspect, periodic measurement and calculation are carried out, and comparison is carried out by using the amount of change from the resistance value of one cycle before. Therefore, abnormalities at the time when the heater operates can be detected rapidly.

An abnormality determination device of a third aspect is the abnormality determination device of the first or second aspect that includes an update section that updates a minimum value and a maximum value of the resistance value calculated by the calculation section, wherein the comparison section compares the minimum value and the resistance value calculated at the current time, and compares the maximum value and the resistance value calculated at the current time, respectively, and the detection section detects an abnormality of the heater in a case in which either comparison value exceeds a threshold value.

In accordance with the abnormality determination device of the third aspect, stored values, which are obtained by updating the minimum value and the maximum value of the resistance value of the time of normal operation, are used as threshold values and are compared with the resistance value at a current time. Therefore, abnormalities at the time of the early stage of operation of the heater can be detected.

An abnormality determination device of a fourth aspect is the abnormality determination device of any of the first through third aspect, wherein the heater is formed from a material containing electrically-conductive, minute carbon structures.

An abnormality determination device of a fifth aspect is the abnormality determination device of the fourth aspect, wherein the heater is a planar heater formed from a material containing carbon nanotubes.

In accordance with the abnormality determination devices of the fourth and fifth aspects, not only can the heater heat uniformly over the entirety thereof, but the heater also can heat rapidly. Therefore, a heater having a good feel of use can be provided.

An abnormality determination device of a sixth aspect is the abnormality determination device of any of the first through fifth aspects that includes an acquisition section that acquires an environmental temperature of a periphery of the heater, wherein the detection section detects an abnormality of the heater by using the threshold value, which has been corrected on the basis of the environmental temperature acquired by the acquisition section or the resistance value, which has been corrected on the basis of the environmental temperature.

In accordance with the abnormality determination device of the sixth aspect, because the threshold value or the resistance value is corrected to an appropriate value in accordance with the environmental temperature of the periphery of the heater, abnormalities can be detected more accurately.

An abnormality determination device of a seventh aspect is the abnormality determination device of any of the first through sixth aspects that further includes a receiving section that receives a voltage value and a current value of the heater, wherein the calculation section calculates the resistance value on the basis of a maximum value of the voltage value, which is fluctuating, received by the receiving section and a maximum value of the current value, which is fluctuating, received by the receiving section.

In accordance with the abnormality determination device of the seventh aspect, even in a case in which the current value and the voltage value fluctuate, the resistance value can be calculated stably, and the accuracy of detecting abnormalities of the heater can be ensured.

An eighth aspect is an abnormality determination method in which a computer performs processing include: calculating a resistance value of a heater; comparing the resistance value calculated in the past and the resistance value calculated at a current time; and detecting an abnormality of the heater in a case in which a comparison value exceeds a threshold value.

A ninth aspect is an abnormality determination program causing a computer to perform processing include: calculating a resistance value of a heater; comparing the resistance value calculated in the past and the resistance value calculated at a current time; and detecting an abnormality of the heater in a case in which a comparison value exceeds a threshold value.

### Advantageous Effects of Invention

In accordance with the present disclosure, localized abnormalities of a heater can be detected.

### BRIEF DESCRIPTION OF DRAWINGS

FIG. 1 is a block drawing illustrating hardware structures of a vehicle.

FIG. 2 is a block drawing illustrating functional structures of a heater ECU.

FIG. 3 is a drawing for explaining use of maximum values of the voltage value and the current value that fluctuate periodically.

FIG. 4 is a drawing for explaining an example of the temperature distribution at the time of localized damage of a planar CNT heater.

FIG. 5 is a flowchart illustrating an example of abnormality determining processing at a time of operation of the CNT heater.

FIG. 6 is a flowchart illustrating an example of abnormality determining processing at a time of an early stage of operation of the CNT heater.

FIG. 7 is a drawing for explaining an example of the temperature distribution at the time of semi-disconnection of a nichrome wire.

### DESCRIPTION OF EMBODIMENTS

This application is based on Japanese Patent Application No. 2022-128977 filed in Japan on Aug. 12, 2022, the contents of which form a portion of the contents of the present application.

Further, the present disclosure can be can be understood more completely from the following detailed explanation. A broader scope of application of the present application will become more clear from the following detailed explanation. However, this detailed explanation and the specific actual examples are preferred embodiments of the present disclosure and are put forth only for the purpose of explanation. From this detailed explanation, various changes and modifications within the spirit and scope of the present disclosure will be clear to those skilled in the art.

Among the disclosed modifications and alternatives, which the present applicant does not intend to present publicly, of the described embodiments, structures that may not be expressly included in the Claims also are part of the invention under the doctrine of equivalents.

Examples of embodiments of the present disclosure are described hereinafter with reference to the drawings.

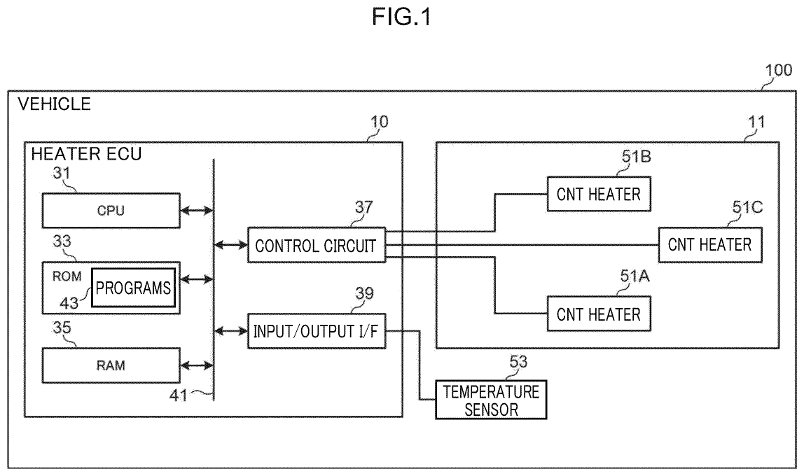

FIG. 1 illustrates hardware structures of a vehicle 100 that includes a heater ECU 10. As illustrated in FIG. 1, the heater ECU 10 serving as an example of an abnormality determination device relating to the present embodiment is exemplified as being installed in the vehicle 100. The vehicle 100 may be structured to include, in addition to the heater ECU 10, a vehicle seat 11, heaters 51, and a temperature sensor 53.

The vehicle seat 11 may be structured to include the plural heaters 51 at the interior thereof. Specifically, the heaters 51 may include heater 51A, heater 51B and heater 51C. The heater 51A, the heater 51B and the heater 51C may be set at respective portions of the vehicle seat 11, and have the function of warming the body of a passenger. The heaters 51 are planar and may be structured to include electrically-conductive, minute carbon structures. Examples of electrically-conductive, minute carbon structures are CNTs (Carbon Nano Tubes) and CPTs (Carbon Pico Tubes). The respective heaters 51 are connected to the heater ECU 10, and the absence/presence of the occurrence of abnormalities thereof is monitored.

The temperature sensor 53 is a sensor for detecting the temperature at the periphery of the heaters 51. The temperature sensor 53 may be connected to the heater ECU 10. The temperature sensor 53 can be mounted to the heaters 51 or the vehicle seat 11.

The respective numbers of the heater ECUs 10, the heaters 51 and the temperature sensors 53 that are included in the vehicle 100 are not limited to those of the example of FIG. 1. For example, two or more of each of the heater ECU 10 and the temperature sensor 53 may be included, and the vehicle seat 11 may be structured by an arbitrary number of the CNT heaters 51. Further, the vehicle 100 of the present embodiment may have plural vehicle seats 11. In this case, the respective heaters 51 may be controlled by the single heater ECU 10, or the respective heaters 51 may be controlled by the heater ECU 10 that is provided for each vehicle seat 11.

The heater ECU 10 has the function of controlling the respective heaters 51 that the vehicle seat 11 has. As illustrated in FIG. 1, the heater ECU 10 can be structured by a computer having a CPU (Central Processing Unit) 31, a ROM (Read Only Memory) 33, a RAM (Random Access Memory) 35, a control circuit 37 and an input/output I/F (Interface) 39. These CPU 31, ROM 33, RAM 35, control circuit 37 and input/output I/F 39 may be connected so as to be able to communicate with one another via internal bus 41.

The respective heaters 51 may be connected to the control circuit 37. The control circuit 37 controls the outputs of the respective heaters 51, and may have a function of detecting the voltage values and current values of the respective heaters 51. Further, the temperature sensor 53 that is set in a vicinity of the vehicle seat 11 may be connected to the input/output I/F 39.

The CPU 31 is a central computing processing unit, and can perform various programs and can control respective structures. Namely, the CPU 31 can be said to be a processor that reads-out programs 43 from the ROM 33 and performs the programs 43 by using the RAM 35 as a workspace. The CPU 31 can carry out control of the above-described respective structures, and various types of computing processing, in accordance with the programs 43 that are stored in the ROM 33.

The ROM 33 can store various programs, including the operating system, and various data. An abnormality determination program for executing abnormality determining processing that is described later may be stored in the ROM 33. Note that a recording medium that is an HDD (Hard Disk Drive), an SSD (Solid State Drive) or a flash memory may be provided in place of or in addition to the ROM 33. Further, the RAM 35 can temporarily store programs and data as a workspace.

The control circuit 37 can be structured by a circuit formed from a PWM (Pulse Width Modulation) controller, a voltage detecting section and a current detecting section.

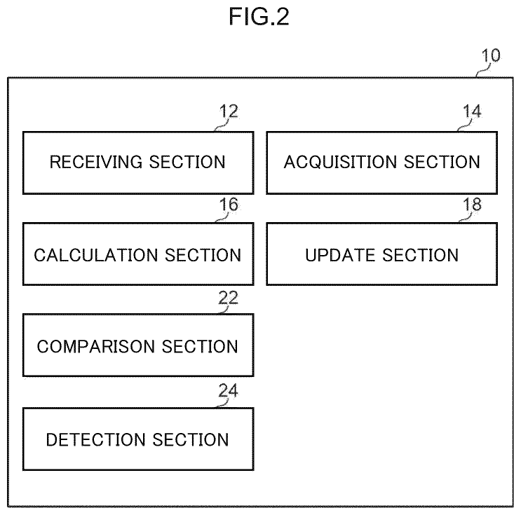

Functional structures of the heater ECU 10 relating to the present embodiment are described next with reference to FIG. 2. As illustrated in FIG. 2, due to the CPU 31 executing the abnormality determination program stored in the ROM 33, the heater ECU 10 of the present embodiment can function as a receiving section 12, an acquisition section 14, a calculation section 16, an update section 18, a comparison section 22 and a detection section 24.

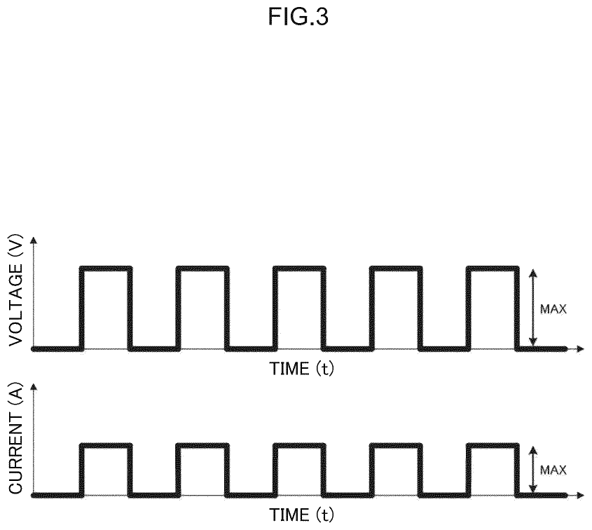

The receiving section 12 may have the function of receiving voltage values and current values detected at the control circuit 37. The receiving section 12 can receive voltage values and current values that fluctuate due to PWM control. FIG. 3 is a drawing explaining changes over time in the voltage value and the current value at the heater 51. As a result of PWM control, the graphs of the voltage value and the current value received at the receiving section 12 are shaped as pulse waves (see FIG. 3).

As illustrated in FIG. 2, the acquisition section 14 may have the function of acquiring the environmental temperature of the periphery of the heaters 51. The acquisition section 14 can, via the input/output I/F 39, acquire temperature information that is measured by the temperature sensor 53.

The calculation section 16 has the function of calculating the resistance values of the heaters 51. The calculation section 16 can periodically calculate the resistance values of the heaters 51. Specifically, the calculation section 16 calculates the resistance value by dividing the voltage value received by the receiving section 12 by the current value received by the receiving section 12. Note that, because the voltage values and the current values received by the receiving section 12 fluctuate, the calculation section 16 of the present embodiment calculates the resistance value on the basis of the maximum values thereof, as illustrated in FIG. 3.

As illustrated in FIG. 2, the update section 18 may have the function of updating the minimum value and the maximum value of the resistance value calculated by the calculation section 16, and storing the values in the ROM 33. Specifically, by updating and storing the minimum value and the maximum value of the resistance value of the time of normal operation, the update section 18 can set those values to be threshold values, which are described later, at the time of the early stage of operation of the heater 51.

The comparison section 22 has the function of comparing a past resistance value calculated by the calculation section 16 and the resistance value calculated at a current time. Specifically, while the heater 51 is operating, the comparison section 22 of the present embodiment compares the resistance value, which was calculated by the calculation section 16 for the cycle of one time before, and the resistance value calculated for the current cycle. Further, at the time of the early stage of operation of the heater 51 (in detail, at the time when the power source is turned on), the comparison section 22 compares the minimum value and the maximum value of the resistance value, which were updated at the update section 18, with the resistance value calculated for the current cycle, respectively. Note that the respective comparison values, which are the values obtained as the results of comparison at the comparison section 22, are not limited to differences, and may be rates of change for example. In a case in which the comparison values are expressed as rates of change, also when setting the first threshold value and the second threshold value that are described later, it is good to set the first threshold value and the second threshold value as threshold values with respect to the rate of change.

As a pre-processing, the detection section 24 can correct the threshold value or the resistance value on the basis of the environmental temperature of the heater 51 that is acquired by the acquisition section 14. The detection section 24 has the function of detecting an abnormality of the heater in a case in which any comparison value at the comparison section 22 exceeds a threshold value. Here, in the present embodiment, a first threshold value for detecting during operation of the heater 51, and a second threshold value for detecting at the time of the early stage of operation of the heater 51, are provided as threshold values. Further, the detection section 24 may stop the power source of the heater 51 by detecting an abnormality.

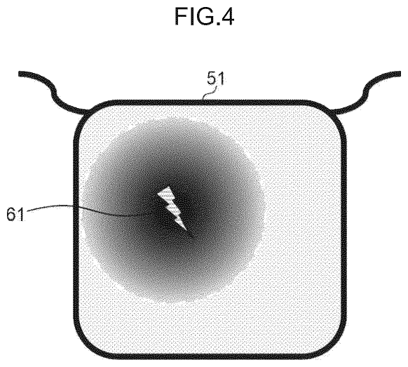

The heater ECU 10 can detect abnormalities of the heater 51 and carry out control by the above-described functions. FIG. 4 is a drawing explaining the distribution of the peripheral temperatures of localized damage of the heater 51 that is planar. Note that, in FIG. 4, as an example, a state in which, the nearer to a damaged region 61, the higher the temperature, is expressed by shading. For example, as illustrated in FIG. 4, in a case in which the heater 51 is damaged locally, the temperature rises locally at the periphery of the damaged region 61. Here, because current is flowing at the heater 51 at regions other than the damaged region 61, the aforementioned localized damage cannot be detected by conventional, simple detecting of disconnection. Thus, in the present embodiment, the abnormality of the heater 51 is detected by using the resistance value that fluctuates in accordance with the localized damage of the heater 51. As described above, because current continues to flow even in a case in which the heater 51 is damaged locally, it is difficult to detect changes in temperature. Therefore, in the present embodiment, by detecting an abnormality by the amount of the change in the resistance value as the control by the heater ECU 10, the accuracy of detecting abnormalities of the heater 51 is improved. Note that the heater ECU 10 can detect abnormalities not only at the time of localized damage, but can also detect abnormalities at the time of complete damage because the resistance value exceeds a threshold value.

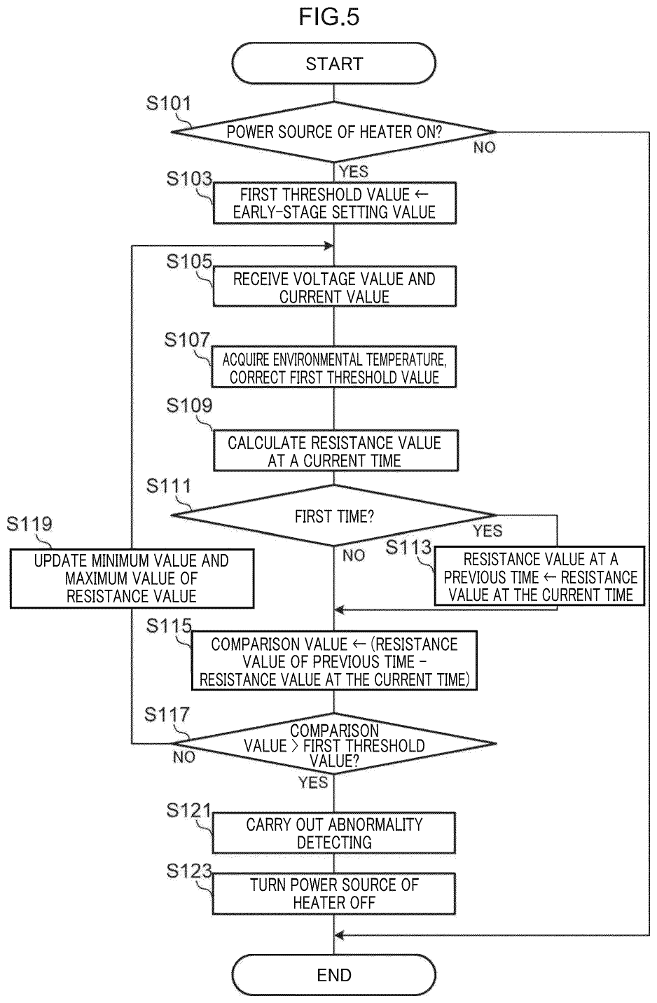

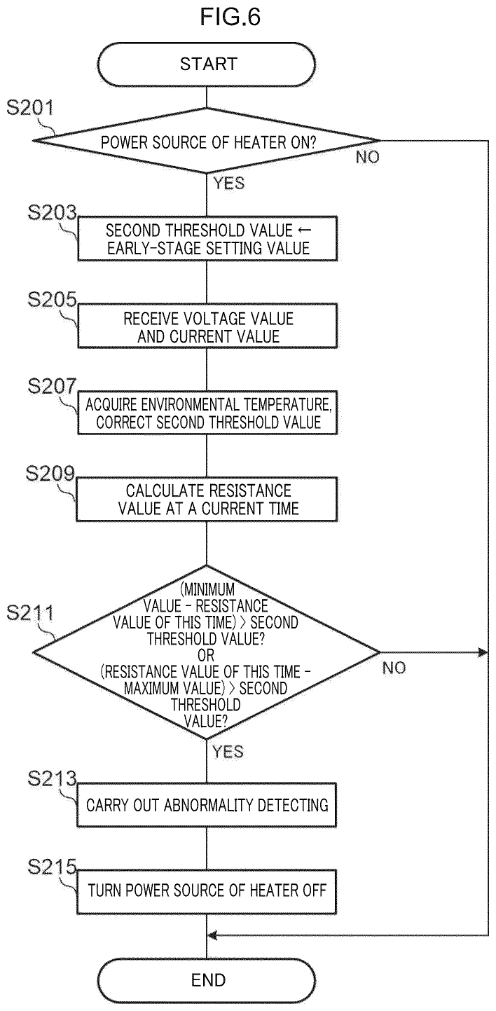

Operation of the heater ECU 10 relating to the present embodiment is described next. The abnormality determining processing at the time of normal operation of the heater 51 that is illustrated in FIG. 5, and the abnormality determining processing at the time of the early stage of operation of the heater 51 that is shown in FIG. 6, are performed at the vehicle 100. The respective processings at the heater ECU 10 are performed due to the CPU 31 or the like functioning as the receiving section 12, the acquisition section 14, the calculation section 16, the update section 18, the comparison section 22 and the detection section 24. Note that the respective abnormality determining processings are an example of the abnormality determination method of the present disclosure.

The abnormality determining processing at the time of normal operation of the heater 51 is described with reference to FIG. 5.

First, in step S101, the CPU 31 judges whether or not the power source of the heater 51 is ON. If the CPU 31 judges that the power source of the heater 51 is not ON, i.e., is OFF (step S101: NO), the CPU 31 ends processing. On the other hand, if the CPU 31 judges that the power source of the heater 51 is ON (step S101: YES), the CPU 31 moves on to step S103.

Next, in step S103, the CPU 31 substitutes an early-stage setting value in for the first threshold value of the resistance value of the heater 51. Here, the early-stage setting value is a default value, and an arbitrary value can be set therefor.

Next, in step S105, the CPU 31 receives the voltage value and the current value.

Next, in step S107, the CPU 31 acquires the environmental temperature of the periphery of the heater 51 from the temperature sensor 53, and corrects the first threshold value on the basis of the environmental temperature.

Next, in step S109, the CPU 31 calculates the resistance value of the heater 51 at a current time.

Next, in step S111, the CPU 31 judges whether or not the calculating of the resistance value after the power source of the heater 51 operates is calculation of the first time. If the CPU 31 judges that the calculating of the resistance value after the power source of the heater 51 operates is the first-time calculation (S111: YES), the CPU 31 moves on to step S113. On the other hand, in step S111, if the CPU 31 judges that the calculating of the resistance value after the power source of the heater 51 operates is not the first-time calculation (S111: NO), the CPU 31 moves on to step S115.

In step S113, the CPU 31 substitutes the resistance value at the current time in for the resistance value at the previous time.

In step S115, the CPU 31 holds, as a comparison value, a change amount that is the difference between the resistance value at the previous time and the resistance value at the current time of the heater 51.

Next, in step S117, the CPU 31 judges whether or not the comparison value, which is the amount of change in the resistance value from one cycle before, exceeds the first threshold value. If the CPU 31 judges that the comparison value does not exceed the first threshold value (step S117: NO), the CPU 31 moves on to step S119. On the other hand, if the CPU 31 judges that the comparison value exceeds the first threshold value (step S117: YES), the CPU 31 moves on to step S121.

In step S119, the CPU 31 updates the minimum value and the maximum value of the resistance value, and thereafter, returns to step S105. Then, the CPU 31 repeats above-described step S105 through step S119 each predetermined cycle.

In step S121, the CPU 31 carries out abnormality detecting. In this case, the CPU 31 can take the opportunity of having detected an abnormality to notify the passenger of an abnormality. Note that it is not absolutely necessary to detect an abnormality, i.e., step S121 can be rendered unnecessary. In this case, the CPU 31 may move on from step S117 (in a case in which the result of the judgement is YES) to step S123.

In step S123, the CPU 31 turns the power source of the heater 51 OFF. Then, the CPU 31 ends the abnormality determining processing.

Abnormality determining processing at the time of the early stage of operation of the heater 51 is described with reference to FIG. 6.

In step S201, the CPU 31 judges whether or not the power source of the heater 51 is ON. If the CPU 31 judges that the power source of the heater 51 is not ON, i.e., is OFF (step S201: NO), the CPU 31 ends processing. On the other hand, if the CPU 31 judges that the power source of the heater 51 is ON (step S201: YES), the CPU 31 moves on to step S203.

Next, in step S203, the CPU 31 substitutes an early-stage setting value in for the second threshold value of the resistance value of the heater 51. Here, the early-stage setting value is a default value, and an arbitrary value can be set therefor.

Next, in step S205, the CPU 31 receives the voltage value and the current value.

Next, in step S207, the CPU 31 acquires the environmental temperature of the periphery of the heater 51 from the temperature sensor 53, and corrects the second threshold value on the basis of the environmental temperature.

Next, in step S209, the CPU 31 calculates the resistance value of the heater 51 at the current time.

Next, in step S211, the CPU 31 judges whether or not the difference between the resistance value at the current time and the minimum value, or the difference between the resistance value at the current time and the maximum value, exceeds the second threshold value. Here, the minimum value and the maximum value are the minimum value and the maximum value of the resistance value that were updated in step S119 of FIG. 5 at the time of using the heater 51 the previous time. Note that, at the time of the first-time usage of the heater 51 that has not yet been used, arbitrary early-stage values may be set for the minimum value and the maximum value. If the CPU 31 judges that both of the differences do not exceed the second threshold value (step S211: NO), the CPU 31 ends processing. On the other hand, in step S211, if the CPU 31 judges that either of the differences exceeds the second threshold value (step S211: YES), the CPU 31 moves on to step S213.

Next, in step S213, the CPU 31 carries out abnormality detecting. In this case, the CPU 31 can take the opportunity of having detected an abnormality to notify the passenger of an abnormality. Note that it is not absolutely necessary to detect an abnormality, i.e., step S213 can be rendered unnecessary. In this case, the CPU 31 may move on from step S211 (in a case in which the result of the judgement is YES) to step S215.

In step S215, the CPU 31 turns the power source of the heater 51 OFF. Then, the CPU 31 ends the abnormality determining processing.

### Overview

As described above, in the present embodiment, the resistance value of the heater 51 is calculated, and a past, calculated resistance value and the resistance value calculated at a current time are compared, and an abnormality of the heater 51 is detected in a case in which the comparison value exceeds a threshold value. Accordingly, in accordance with the present embodiment, an abnormality can be detected even in a case in which a CNT heater is damaged locally.

Further, in the present embodiment, at the time of normal operation, the resistance value is calculated periodically, and the calculated resistance value at the previous time and the resistance value calculated at the current time are compared. Then, an abnormality of the heater 51 is detected if the amount of change in the resistance value, which serves as a comparison value, exceeds a first threshold value. At the heater 51, at normal times, the amount of change in the resistance value per cycle is a small value, whereas at abnormal times, the amount of change in the resistance value per cycle is a large value. Therefore, an abnormality can be detected by comparing the comparison value and the first threshold value. Namely, in accordance with the present embodiment, periodic measurement and calculation are carried out, and comparison is carried out by using the amount of change from the resistance value of the one cycle before. Therefore, an abnormality at the time of operation of the heater 51 can be detected rapidly.

Further, in the present embodiment, at the time of the early stage of operation, the minimum value and maximum value of the calculated resistance value are updated, and the minimum value and the resistance value calculated at the current time, and the maximum value and the resistance value calculated at the current time, are respectively compared, and an abnormality of the heater is detected in a case in which either of the comparison values exceeds a second threshold value. In other words, in the present embodiment, an abnormality at the time of the early stage of operation of the heater 51 is detected by comparing stored values, which are obtained by updating the minimum value and maximum value of the resistance value of the time of normal operation, with the resistance value at the current time, and comparing comparison values, which are specified by the amounts of change in these resistance values, with the second threshold value. Note that, in the present embodiment, the second threshold value for detecting an abnormality, which is based on the amount of change with respect to the minimum value, and the second threshold value for detecting an abnormality, which is based on the amount of change with respect to the maximum value, are set to be the same value, but may be set to be different values.

Further, the heater 51 of the present embodiment can be structured of a material that includes electrically-conductive, minute carbon structures. In particular, the heater 51 of the present embodiment can be structured by a planar heater that is formed from a material containing carbon nanotubes. Accordingly, not only can the heater 51 of the present embodiment heat uniformly over the entirety thereof, but the heater 51 also can heat rapidly. Therefore, a heater having a good feel of use can be obtained.

Further, in the present embodiment, the environmental temperature of the periphery of the heater 51 is acquired, and an abnormality of the heater can be detected by using a threshold value that has been corrected on the basis of the acquired environmental temperature or a resistance value that has been corrected on the basis of the environmental temperature. Accordingly, in accordance with the present embodiment, the threshold value or resistance value is corrected to an appropriate value in accordance with the environmental temperature of the periphery of the heater 51, and therefore, abnormalities can be detected even more accurately.

Further, in the present embodiment, the voltage value and the current value of the heater 51 are received, and the resistance value is calculated on the basis of the maximum value of the fluctuating voltage value that is received and the maximum value of the fluctuating current value that is similarly received. Accordingly, in accordance with the present embodiment, even in a case in which the current value and the voltage value fluctuate such as in the case of PWM control, the resistance value can be calculated stably, and the accuracy of detecting abnormalities of the heater 51 can be ensured.

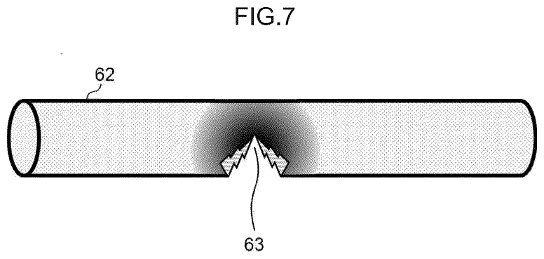

Note that the present embodiment describes an example of using a CNT heater as the heater whose abnormalities are detected, but the present disclosure can also be utilized in detecting abnormalities at the time of semi-disconnection of a nichrome wire that is an electrically heated wire. FIG. 7 is a drawing explaining the distribution of peripheral temperatures at the time of semi-disconnection of a nichrome wire 62, and is a drawing illustrating an example in which heat continues to be transferred even at the time of damage. Note that, in FIG. 7, as an example, a state in which, the nearer to a semi-disconnected region 63, the higher the temperature, is expressed by shading. If the nichrome wire 62 were to be completely disconnected, current would no longer flow, and therefore, detecting of an abnormality based on conventional detecting of a disconnection would be possible. However, in a case in which current continues to flow even at the time of damage such as semi-disconnection of the nichrome wire 62, detecting of an abnormality by detecting the disconnection is difficult, in the same way as in the case of a CNT heater. However, by utilizing the above-described heater ECU 10, an abnormality can be detected even if it is an abnormality due to such localized damage of the nichrome wire 62.

Further, although the present embodiment describes an example in which a vehicle seat is used as the place where the heater is set, the heater ECU can also be utilized in other products that can use a CNT heater, such as clothes or chairs other than those of a vehicle.

### Notes

Note that, although the above embodiment describes an example in which the first threshold value and the second threshold value are corrected on the basis of the environmental temperature acquired from the heater 51, the present disclosure is not limited to this. For example, the resistance value calculated at the calculation section 16 may be corrected on the basis of the environmental temperature.

The abnormality determining processing, which is performed by the CPU reading-in a software program in the above-described embodiment, may be performed by any of various types of processors other than a CPU. Examples of processors in this case include PLDs (Programmable Logic Devices) whose circuit structure can be changed after production such as FPGAs (Field-Programmable Gate Arrays), and dedicated electrical circuits that are processors having circuit structures that are designed for the sole purpose of executing specific processings such as ASICs (Application Specific Integrated Circuits). Further, the transmitting processing may be performed by one of these various types of processors, or may be performed by a combination of two or more of the same type or different types of processors (e.g., plural FPGAs, or a combination of a CPU and an FPGA). Further, the hardware structures of these various types of processors are, more specifically, electrical circuits that combine circuit elements such as semiconductor elements.

Further, the above embodiment describes a form in which the abnormality determination program is stored in advance (is installed) in a storage device, but the present disclosure is not limited to this. The program may be provided in a form of being recorded on a recording medium such as a CD-ROM, a DVD-ROM (Digital Versatile Disc Read Only Memory), or a USB (Universal Serial Bus) memory. Further, the program may be in a form of being downloaded over a network from an external device.

All publications including periodicals, patent applications and patents that are cited in the present specification are incorporated by reference herein to the same extent as if each publication were to be individually and specifically incorporated by reference or all of the contents thereof were to be described herein.

The use of nouns and similar instructions that are used in relation to the explanation of the present disclosure (in relation to the following Claims in particular) are to be interpreted as covering both singular and plural forms, provided that such is not specified otherwise in the present specification nor is in obvious contradiction to the context. The words and phrases “equipped with”, “having”, “including” and “incorporating” are to be interpreted as open-ended terms (i.e., meaning “including . . . but not limited thereto”), unless otherwise specified. The stating of the numerical value ranges in the present specification is merely intended to function as shorthand notation for individually mentioning the corresponding respective values within the range, and each value is incorporated into the present specification as if individually exemplified in the specification, unless otherwise noted in the specification. All of the methods explained in the present specification can be carried out in any appropriate order, provided that such is not specified otherwise in the present specification nor is in obvious contradiction to the context. All examples and exemplifying expressions (e.g., “and the like”) that are used in the present specification are, unless otherwise stated, merely intended to better explain the present disclosure and do not limit the scope of the present disclosure. All expressions in the specification as well are not to be interpreted as meaning that elements that are not recited in the Claims are indispensable to implementation of the present disclosure.

The present specification includes best forms known by the present inventors for implementing the present disclosure, and preferred embodiments of the present disclosure are described. Modifications of these preferred embodiments will be clear to those skilled in the art upon reading the above description. The present inventors anticipate that experts will appropriately apply such modifications, and intend that the present disclosure will be implemented by methods other than those specifically described in the present specification. Accordingly, the present disclosure includes all alterations and equivalents of the contents recited in the Claims appended to the present specification as permitted by governing law. Moreover, all combinations of the above-described elements in all of the modifications also are incorporated into the present disclosure, provided that such is not otherwise specified in the specification nor is in obvious contradiction to the context.

1. An abnormality determination device comprising a processor, wherein the processor is configured to:
calculate a resistance value of a heater;
compare the resistance value that was calculated in the past, and the resistance value calculated at a current time; and
detect an abnormality of the heater in a case in which a comparison value exceeds a threshold value.

2. The abnormality determination device of claim 1, wherein the processor is further configured to:
calculate the resistance value periodically, and
compare the resistance value that was calculated at a previous time, and the resistance value calculated at the current time.

3. The abnormality determination device of claim 1, wherein the processor is further configured to:
update a minimum value and a maximum value of the resistance value,
compare the minimum value and the resistance value calculated at the current time, and the maximum value and the resistance value calculated at the current time, respectively, and
detect an abnormality of the heater in a case in which either comparison value exceeds a threshold value.

4. The abnormality determination device of claim 1, wherein the heater is formed from a material containing electrically-conductive, minute carbon structures.

5. The abnormality determination device of claim 1, wherein the heater is a planar heater formed from a material containing carbon nanotubes.

6. The abnormality determination device of claim 1, wherein the processor is further configured to:
acquire an environmental temperature of a periphery of the heater, and
detect an abnormality of the heater by using the threshold value, which has been corrected on the basis of the environmental temperature, or the resistance value, which has been corrected on the basis of the environmental temperature.

7. The abnormality determination device of claim 1, wherein the processor is further configured to:
receive a voltage value and a current value of the heater, and
calculate the resistance value on the basis of a maximum value of the voltage value; which is fluctuating; and a maximum value of the current value; which is fluctuating.

8. An abnormality determination method, according to which a computer performs processing, comprising:
calculating a resistance value of a heater;
comparing the resistance value calculated in the past and the resistance value calculated at a current time; and
detecting an abnormality of the heater in a case in which a comparison value exceeds a threshold value.

9. A non-transitory computer-readable storage medium containing an abnormality determination program, executable by a computer to perform processing, comprising:
calculating a resistance value of a heater;
comparing the resistance value calculated in the past and the resistance value calculated at a current time; and
detecting an abnormality of the heater in a case in which a comparison value exceeds a threshold value.
